(19) United States
(12) Patent Application Publication
(10) Pub. No.: US 2026/0065713 A1
(43) Pub. Date: Mar. 5, 2026

(54) MAIL SIGNATURE VERIFICATION SYSTEM

(71) Applicant: Tritek Technologies, Inc., Wilmington, DE (US)

(72) Inventors: James Malatesta, Hockessin, DE (US); Kurt Hecht, Rydal, PA (US); Edward Cohen, Mount Laurel, NJ (US)

(21) Appl. No.: 19/386,798

(22) Filed: Nov. 12, 2025

Related U.S. Application Data
(63) Continuation-in-part of application No. PCT/US2024/029095, filed on May 13, 2024.
(60) Provisional application No. 63/501,812, filed on May 12, 2023.

(51) Int. Cl. G06V 40/30; G06V 10/145; G06V 10/28; G06V 10/74

(52) U.S. Cl. CPC G06V 40/33; G06V 10/145; G06V 10/28; G06V 10/74

(57) ABSTRACT

A mail signature verification system employs a software that is configured to remove pixels of a digital photograph taken of a signature through an opaque security window. The mail piece can be signed and then the signature is covered with the signature cover having a security window therein. The signature reading station of a mail processing machine compresses the security window against a press plate and illuminates the signature with a light element while taking the digital photograph. The software then analyzes the digital photograph to remove pixels having a grey scale value below an upper grey scale threshold and remove pixels above a lower grey scale threshold, thereby rendering a signature with these darkest of pixels over the lightest of pixels.

### CROSS REFERENCE TO RELATED APPLICATIONS

This application is a continuation in part of international patent application No. PCT/US2024/029095, having an international filing date of May 13, 2024, which claims the benefit of priority to U.S. provisional patent application No. 63/501,812 , filed on May 12, 2023; the entirety of all priority applications are hereby incorporated by reference herein.

### BACKGROUND OF THE INVENTION

### Field of the Invention

The invention relates to a mail signature verification system that enables determination of a signature through a security window of a security cover without removal of the cover and security window.

### Background

Signing ballots and tax returns is required in many states and also for federal election and taxes, respectively. In order to protect the person's signature, the signature is typically covered on the envelope, requiring the cover to be removed of the envelope to be opened to confirm the signature. There exists a need for a system to enable a signature to be verified on a piece of mail without the removal of a cover or opening the mail piece.

### SUMMARY OF THE INVENTION

The invention is directed to a mail signature verification system that employs a software that is configured to remove pixels of a digital photograph taken of a signature through an opaque security window. The mail piece can be signed and then the signature is covered with the signature cover having a security window therein. The signature reading station of a mail processing machine compresses the security window against a press plate and illuminates the signature with a light element while taking the digital photograph. The software then analyzes the digital photograph to remove pixels having a grey scale value below an upper grey scale threshold and remove pixels above a lower grey scale threshold, thereby rendering a signature with these darkest of pixels over the lightest of pixels.

An exemplary mail piece has a signature area and a signature cover configured to extend over the signature area and obscure the signature from reading by eye. A security window in the signature cover that may include an opaque polymer or plastic that effectively prevents reading or recognition of the signature by human eye with an 80 lumen or less light shining on the security window and when the signature is made with a ball point pen in black ink. It should be noted that a signature with other writing implements such as a pencil would also not be discernable or recognizable through the signature cover with the 80 lumen light. The security window may be any suitable color and may include a pigment to effectively obscure the signature as described herein and prevent reading the signature therethrough. The mail piece may be a package or an envelope. In the case of an envelope, the signature cover may be the envelope flap that extends over the opening to the envelope. The security window may be a portion of the envelope flap, for example. It should be noted that the security cover or security window of the security cover may cover other secondary information such as driver's license number, social security number, address, tax ID number, account number, or witness signature, or personal information, or anything that needs to be hidden and secure on an envelope. The mail signature verification system may also be configured to identify this secondary information through the security window, wherein the secondary information is binarized information through the software as described herein.

An exemplary mail signature verification system includes a mail processing system that moves mail pieces therethrough and has a signature reading station for taking a digital photograph of the security window and signature thereunder. The mail pieces may be passed into and out of the signature reading station by an inlet actuator and an outlet actuator, respectively. The actuators may be rollers or belts and the mail pieces may move continuously through the signature reading station without stopping. A camera is configured to take a digital photograph as the mail piece moves through the signature reading station and may be configured at an offset angle from orthogonal to the security window as the photograph is taken of the mail piece. This offset angle may prevent glare from light projected onto the security window by a light element. A light element may be configured to emit light onto the security window and the light may be about 50 lumens or more, about 80 lumens or more, about 100 lumens or more, about 150 lumens or more and any range between and including the lumen values provided; wherein the lumens are calculated at the security window distance from the light element.

The light element may emit light and a focal lens may be configured between the emitted light and the press plate and security window to focus the light for more effective and reliable detection and reading of signature through the security window. The focal lens may be a rod having a circular cross-sectional shape and may be made of a translucent material such as glass or a clear plastic such as acrylic. The focal lens may receive light from one light element or a plurality of light elements, such as two more, three or more, four or more or even five or more and the focal lens may deflect the light to produce a focused light, such as a light band having a width that is narrow, such as no more than about 20 mm, no more than about 15 mm, no more than about 10 mm, no more than about 7.5 mm, no more than about 5 mm and any range between and including the light band widths provided. The more narrow the light band, the greater the intensity of light that may be incident on the security window and therefore enable more effective signature verification. A narrow light band may concentrate the light on the press plate and through the security window to better enable signature detection and reading by the software. The light element or light source may be a light emitting diode.

The digital photographs are then analyzed to identify the signature. The software is configured to remove pixels of the digital photograph that are above a lower threshold value, thereby leaving the most black pixels on a white background for identification of the signature, producing a binarized signature. In some cases, the software may remove pixels above a lower grey scale pixel threshold and below a higher grey scale threshold value, or the obscuring pixels to produce a binarized signature. The removed pixels are represented as no color or white in the analyzed digital photograph. In a gray-scale image, each pixel has a value between 0 and 255, where zero corresponds to “black” and 255 corresponds to “white”. The values between 0 and 255 are varying shades of gray, where values closer to 0 are darker and values closer to 255 are lighter. The lower grey scale threshold may be about 20 or more, about 50 or more, about 75 or more about 100 or less and any range between and including the lower grey scale thresholds provided. Likewise, the upper grey scale threshold may be about 235 or less, about 205 or less, about 180 or less, about 155 or more and any range between and including the upper grey scale values provided.

The binarized signature may then be verified by comparison with a signature of recorded. Identifying the signature means that the software can determine that the signature is present and that the signature can be read or discerned Verifying the signature means that the is compared with a signature of record to verify that is matches the signature of record, which may be done manually or through the software. A signature of record may be provided by a government agency, such as an election office.

This exemplary mail signature verification system may also be used for identifying any information obscured through a security window including, but not limited to, tax information, legal information, any personal information, corporate information such EIN numbers, account numbers, passwords, checked boxes and any information that is required to be hidden from public through the mail.

The summary of the invention is provided as a general introduction to some of the embodiments of the invention and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a mail piece with a signature area and a signature cover having a security window that is configured to cover and obscure the signature from view.

FIG. 2 shows the mail piece shown in FIG. 1, with the signature cover, the envelope flap, folded down over the signature area to obscure the signature from view.

FIG. 3 shows an exemplary mail signature verification system that utilizes a camera to take a digital photograph of the signature through the security window and a computer with software that is configured to run image analysis to enable determination of the signature through the security window; the software subtracts out or removes gray scale portions of the image to enable the signature to be determined.

FIG. 4 shows a perspective view of a light assembly having a focal lens offset from the light element to produce a focused light, or light band.

FIG. 5 shows an exploded view of the light assembly shown in FIG. 4.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

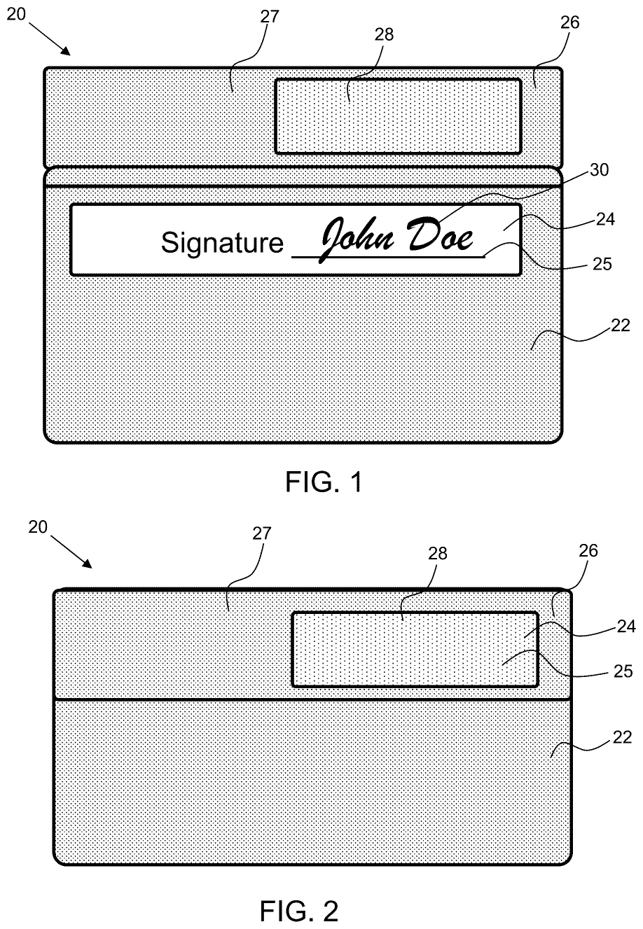

Referring now to FIGS. 1 and 2, a mail piece 20, an envelope 22, is configured with a signature area 24 and a signature cover 26 having a security window 28 that is configured to cover and obscure the signature 30 from view. As shown in FIG. 2, the mail piece 20 now has the signature cover 26, the envelope flap 27, folded down over the signature area 24 to obscure the signature from view. The signature area 24 has a signature line 25 to ensure the signature 30 is configured under the security window 28 when the envelope flap 27 is folded over to seal the envelope 22 closed. As described herein the security window may be a plastic film with pigment or dye to obscure the signature 30 from reading by human eye with the security window directly over the signature and with no more than an 80 lumen light emitted onto the security window.

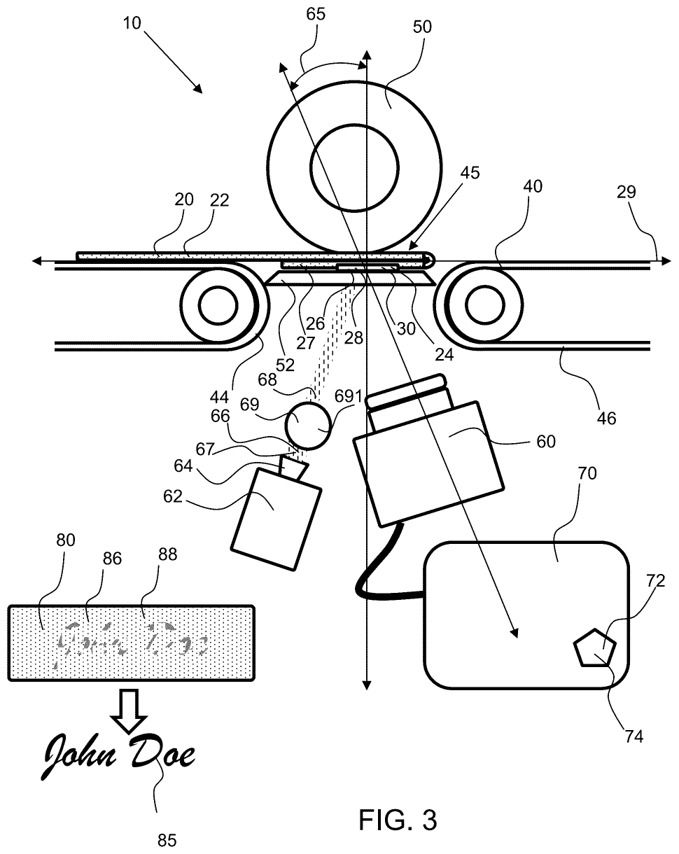

As shown in FIG. 3, an exemplary mail signature verification system 10 utilizes a camera 60 to take a digital photograph 80 of the signature 30 through the security window 28 and a computer 70, with a microprocessor 72, is configured to run software 74 that preforms image analysis of the digital photograph 80 to enable determination of the signature 30 through the security window. The software subtracts out or removes gray scale 86 portions of the image to enable the signature to be determined. Each digital image has pixels 88 that are analyzed for grey scale value from white to black and all pixels having a grey scale value above a lower threshold value are removed, thereby leaving the most black pixels on a white background. In some embodiments, pixels between and upper grey scale threshold value and lower grey scale threshold are removed. The analyzed digital photograph 85 enables verification of the signature 30.

The mail processing machine 40 has an inlet actuator 44, such as a belt, an outlet actuator 46, such as a belt or wheel and a signature reading station 45 configured therebetween. The signature reading station includes the camera 60 that is configured to take a digital photograph of the envelope 22 as it passes through the signature reading station 45. A compression roller 50 may be used to press the envelope and particularly the signature cover 26 and security window 28 against a press-plate 52. The press plate may be or include a transparent or translucent portion to allow a clear photograph through the press plate. A light element 64 may produce light 67, an emitted light 66 through a focal lens 69 to produce a focused light 68, such as a light band 681 having a length and width, onto the press plate 52 and subsequently onto the security window as it passes through the signature reading station 45 and particularly when the security window 28 is pressed against the press-plate 52. This system and method enables the signature to be determined through the signature cover and security window of the signature cover without removal of the signature cover or the security window.

The camera is configured to take the digital photograph 80 at an offset angle 65 from orthogonal to the security window plane 29, to enable improved image capture without glare from the light from the light element 64. As described herein, the offset angle may be about 5 degrees or more, about 10 degrees or more, about 20 degrees or more, about 30 degrees or more and any range between and including the values provided. The offset angle shown in FIG. 3 is large for clarity of this principle only.

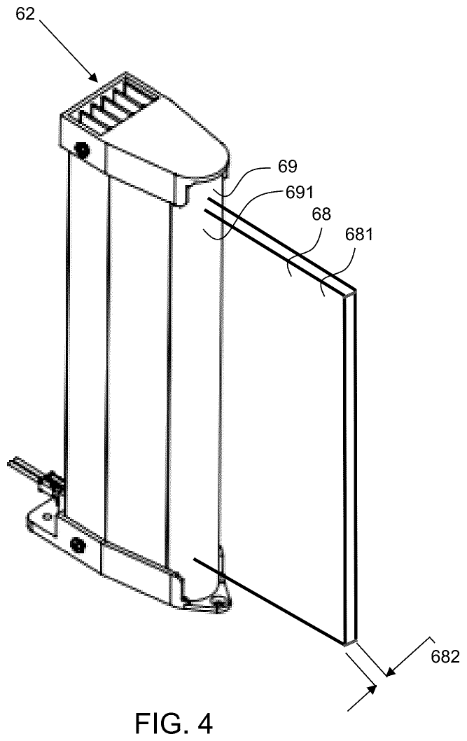

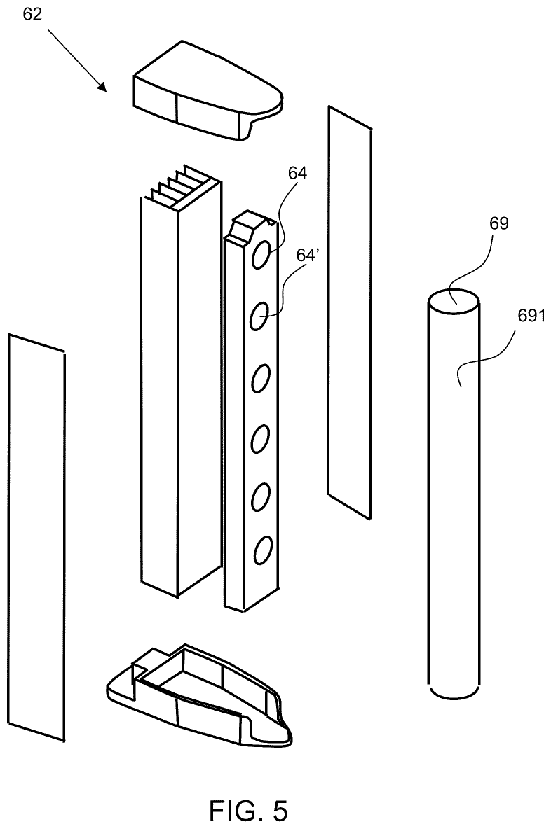

Referring now to FIGS. 4 and 5, a light assembly 62 has a focal lens 69, a focal rod 692 that is offset from the light element 64 to produce a focused light, or light band 681 having a light band width 682. As described herein the focal lens 69 may be glass or plastic and have contoured surfaces to focus the emitted light into a focused light, such as a light band, a strip of light that more effectively enables reading a signature through the security window. The focal lens 69 is a focal rod 691 having a circular cross-sectional shape as shown in FIG. 5. Also, the light assembly includes a plurality of light elements 64, 64′ and the focal lens 69 receives the emitted light 66 from the plurality of light elements and produces a continuous light band 681 for effective reading of a signature through a security window.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A mail signature verification system comprising:
a) a mail piece comprising:
i) a signature area for receiving a signature;
ii) a signature cover configured to extend over the signature in the signature area after the mail piece is signed;
iii) a security window in the signature cover that is effectively opaque to prevent recognition of the signature when an 80 lumen light is directed onto the security window;
b) a mail processing machine comprising:
i) a signature reading station comprising:
a compression roller;
a press-plate configured to press against the compression roller;
a camera configured to take a digital photograph of the security window as the mail piece is moved through the signature reading station; and
a light assembly comprising a element configured to emit light onto the security window in the signature reading station;
ii) an inlet actuator configured to move the mail piece into the signature reading station; and
iii) an outlet actuator configured to move the mail piece out of the signature reading station;
c) a computer configured to receive the digital photograph and operate a software program to analyze the digital photograph to confirm the signature on the mail piece;
wherein the software subtracts out grey scale pixels that are below an upper grey scale threshold and grey scale pixels that are above a lower grey scale threshold, thereby producing a binarized signature for signature verification;
wherein the mail piece in an envelope;
wherein the mail piece moves through the signature reading station without stopping;
wherein the press plate comprises a translucent area to allow the digital photograph to be taken through the press plate;
wherein the light element emits at least 50 lumens of light onto the security window of the mail piece; and
wherein the camera takes the digital photograph along an offset angle from orthogonal to a plane of the security window when between the press plate and the compression roller.

2. The mail signature verification system of claim 1, wherein the mail piece comprises an envelope flap, and wherein the security window is in the envelope flap.

3. The mail signature verification system of claim 1, wherein the inlet actuator comprises a belt and wherein the outlet actuator comprises a belt.

4. The mail signature verification system of claim 1, the signature cover covers secondary information on the mail piece.

5. The mail signature verification system of claim 4, wherein the secondary information is selected from the group consisting of: driver's license number, social security number, address, tax ID number, and account number.

6. The mail signature verification system of claim 5, wherein the software subtracts out grey scale pixels that are below an upper grey scale threshold and grey scale pixels that are above a lower grey scale threshold, thereby producing an analyzed digital photograph that identifies the secondary information.

7. The mail signature verification system of claim 4, wherein the secondary information includes a witness signature.

8. The mail signature verification system of claim 1, wherein the binarized signature is verified through comparison of the binarized signature against a signature of record.

9. The mail signature verification system of claim 1, wherein the light assembly further comprises a focal lens configured between the light element and the press plate, wherein the foal lens focusses the emitted light from the light source into a focused light.

10. The mail signature verification system of claim 9, wherein the focal lens is a focal rod.

11. The mail signature verification system of claim 10, wherein the focal rod is made of a plastic.

12. The mail signature verification system of claim 11, wherein the focused light is a light band.

13. The mail signature verification system of claim 12, wherein the light band has a width of no more than 15 mm.

14. A method of signature verification on a mail piece comprising:
a) providing the mail signature verification system of claim 1,
b) signing the mail piece in the signature area;
c) covering the signature with the signature cover;
d) passing the mail piece with the signature through the signature reading station of the mail processing machine;
e) illuminating the security window as the mail piece moves through the signature reading station and as the digital photograph is being taken by the camera;
f) analyzing the digital photograph with the software operated by the computer to produce an analyzed digital photograph with pixels below an upper grey scale threshold removed and with pixels above a lower grey scale threshold removed.

15. The method of claim 14, wherein the mail piece in an envelope comprising an envelope flap, and wherein the security window is in the envelope flap.

16. The method of claim 14, wherein the inlet actuator comprises a belt and wherein the outlet actuator comprises a belt.

17. The method of claim 14, the signature cover covers secondary information on the mail piece.

18. The method of claim 17, wherein the secondary information is selected from the group consisting of: driver's license number, social security number, address, tax ID number, and account number.

19. The method of claim 18, wherein the software subtracts out grey scale pixels that are below an upper grey scale threshold and grey scale pixels that are above a lower grey scale threshold, thereby producing an analyzed digital photograph that identifies the secondary information.

20. The method of claim 14, wherein the binarized signature is verified through comparison of the binarized signature against a signature of record.
